(19) United States
(12) Patent Application Publication
(10) Pub. No.: US 2026/0304443 A1
(43) Pub. Date: Oct. 1, 2026

(54) METHODS AND APPARATUSES FOR HARQ-ACK CODEBOOK DETERMINATION WHEN MULTIPLE SETS OF SERVING CELLS ARE CONFIGURED FOR MULTI-CELL SCHEDULING

(71) Applicant: LENOVO (BEIJING) LIMITED, Beijing (CN)

(72) Inventor: Haipeng Lei, Beijing (CN)

(21) Appl. No.: 19/477,830

(22) PCT Filed: Feb. 23, 2024
(86) PCT No.: PCT/CN2024/078451

§ 371 Date: Oct. 23, 2025

(51) Int. Cl. H04W 72/232; H04L 1/1812; H04W 72/1273

(52) U.S. Cl. CPC H04W 72/232; H04L 1/1812; H04W 72/1273

(57) ABSTRACT

Embodiments of the present disclosure relate to methods and apparatuses for HARQ-ACK codebook determination when multiple sets of serving cells are configured for multi-cell scheduling. A UE may: receive a first set of DCI formats with each DCI format scheduling a single PDSCH, or not scheduling any PDSCH with required HARQ-ACK feedback; receive a second set of DCI formats with each DCI format scheduling more than one PDSCH, or scheduling one or more PDSCHs and indicating SCell dormancy, wherein each of the more than one PDSCH or the one or more PDSCHs is scheduled on a cell of a set of serving cells among a plurality of sets of serving cells configured for the UE; and transmit a HARQ-ACK codebook including a first HARQ-ACK sub-codebook including HARQ-ACK information bits corresponding to the first set of DCI format and a second HARQ-ACK sub-codebook including HARQ-ACK information bits corresponding to the second set of DCI formats.

### TECHNICAL FIELD

Embodiments of the present disclosure generally relate to wireless communication technology, and more particularly to hybrid automatic repeat request acknowledgement (HARQ-ACK) codebook determination.

### BACKGROUND

A wireless communication system may include one or multiple network communication devices, such as base stations (BS), which may support wireless communication for one or multiple user communication devices, which may be otherwise known as user equipment (UE), or other suitable terminology. The wireless communication system may support wireless communication with one or multiple user communication devices by utilizing resources of the wireless communication system (e.g., time resources (e.g., symbols, slots, subframes, frames, or the like)) or frequency resources (e.g., subcarriers, carriers, or the like). Additionally, the wireless communication system may support wireless communication across various radio access technologies including third generation (3G) radio access technology, fourth generation (4G) radio access technology, fifth generation (5G) (which is also known as new radio (NR)) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some embodiments of the present disclosure provide a UE. The UE may include at least one memory; and at least one processor coupled with the at least one memory and configured to cause the UE to: receive signaling for configuring a plurality of sets of serving cells for multi-cell scheduling; receive a first set of downlink control information (DCI) formats with each DCI format scheduling a single physical downlink shared channel (PDSCH), or not scheduling any PDSCH with required hybrid automatic repeat request acknowledgement (HARQ-ACK) feedback; receive a second set of DCI formats with each DCI format scheduling more than one PDSCH, or scheduling one or more PDSCHs and indicating secondary cell (SCell) dormancy, wherein each of the more than one PDSCH or the one or more PDSCHs is scheduled on a cell of a set of serving cells among the plurality of sets of serving cells; generate a first HARQ-ACK sub-codebook including HARQ-ACK information bits corresponding to the first set of DCI formats; generate a second HARQ-ACK sub-codebook including HARQ-ACK information bits corresponding to the second set of DCI formats; and transmit a HARQ-ACK codebook including the first HARQ-ACK sub-codebook and the second HARQ-ACK sub-codebook.

In some embodiments, each DCI format of the first set of DCI formats includes a counter downlink assignment indicator (DAI) indicating an accumulative number of pairs of a serving cell and a physical downlink control channel (PDCCH) monitoring occasion in which a PDSCH reception with HARQ-ACK feedback enabled or a DCI format with HARQ-ACK feedback required is present, up to a current serving cell and a current PDCCH monitoring occasion.

In some embodiments, counter DAIs of the first set of DCI formats are updated first according to a predefined order of serving cell indexes and then according to a predefined order of PDCCH monitoring occasion indexes.

In some embodiments, in the case that the first set of DCI formats includes at least two DCI formats in a same PDCCH monitoring occasion scheduling respective PDSCHs on a same serving cell, counter DAIs of the at least two DCI formats are updated according to a predefined order of start times for receiving the respective PDSCHs.

In some embodiments, the HARQ-ACK information bits in the first HARQ-ACK sub-codebook are ordered based on counter DAIs of the first set of DCI formats.

In some embodiments, the second HARQ-ACK sub-codebook includes one or more parts, each of which corresponds to a set of serving cells scheduled by the second set of DCI formats among the plurality of sets of serving cells. The one or more parts are ordered based on set indexes of sets of serving cells scheduled by the second set of DCI formats.

In some embodiments, a first DCI format of the second set of DCI formats schedules a serving cell in a first set of serving cells among the plurality of sets of serving cells and a number of HARQ-ACK information bits corresponding to the first DCI format depends on a maximum number of HARQ-ACK information bits per DCI format among DCI formats scheduling the first set of serving cells.

In some embodiments, a first DCI format of the second set of DCI formats schedules a serving cell in a first set of serving cells among the plurality of sets of serving cells, and wherein the first DCI format includes a counter DAI indicating an accumulative number of pairs of a serving cell with a smallest serving cell index among more than one scheduled serving cells and a PDCCH monitoring occasion in which PDSCH receptions are present, up to current more than one scheduled serving cells in the first set of serving cells and a current PDCCH monitoring occasion.

In some embodiments, each DCI format of the second set of DCI formats includes a counter DAI and wherein counter DAIs of DCI formats scheduling different sets of serving cells in the second set of DCI formats are counted separately. In some embodiments, wherein HARQ-ACK information bits in each part of the one or more parts are ordered based on counter DAI(s) of DCI format(s) scheduling a corresponding set of serving cells in the second set of DCI formats.

In some embodiments, each DCI format of the second set of DCI formats includes a counter DAI which is counted among all DCI formats of the second set of DCI formats. In some embodiments, wherein the HARQ-ACK information bits corresponding to the second set of DCI formats in the second HARQ-ACK sub-codebook are ordered based on counter DAI(s) of the second set of DCI formats.

In some embodiments, a first DCI format of the second set of DCI formats schedules a serving cell in a first set of serving cells among the plurality of sets of serving cells and a number of HARQ-ACK information bits corresponding to the first DCI format depends on that of a DCI format having a maximum number of HARQ-ACK information bits among the second set of DCI formats.

In some embodiments, the first DCI format includes a counter DAI indicating an accumulative number of pairs of a serving cell with a smallest serving cell index among more than one scheduled serving cells and a PDCCH monitoring occasion in which PDSCH receptions are present, up to current more than one scheduled serving cells and a current PDCCH monitoring occasion.

In some embodiments, the counter DAI is updated first according to a predefined order of the smallest serving cell index among the more than one scheduled serving cells and then according to a predefined order of PDCCH monitoring occasion index.

In some embodiments, in the case that the second set of DCI formats includes at least two DCI formats in a same PDCCH monitoring occasion and the at least two DCI formats schedule respective PDSCHs on a same serving cell having the smallest serving cell index among respective serving cells scheduled by the at least two DCI formats, counter DAIs of the at least two DCI formats are updated according to a predefined order of start times for receiving the respective PDSCHs.

In some embodiments, the first DCI format schedules a plurality of serving cells in the first set of serving cells, and wherein the current more than one scheduled serving cells include the plurality of serving cells and the PDSCH receptions include PDSCH receptions on the plurality of serving cells.

In some embodiments, the first DCI format schedules at least one serving cell in the first set of serving cells and indicates SCell dormancy by reinterpreting a predefined set of fields associated with a first serving cell in the first set of serving cells, and wherein the current more than one scheduled serving cells include the at least one serving cell and the first serving cell and the PDSCH receptions include PDSCH reception(s) on the at least one serving cell and a virtual PDSCH reception on the first serving cell.

In some embodiments, a first DCI format of the second set of DCI formats schedules a plurality of serving cells in a first set of serving cells, and HARQ-ACK information bits corresponding to the first DCI format are ordered based on serving cell indexes of the plurality of serving cells.

In some embodiments, a first DCI format schedules at least one serving cell in a first set of serving cells and indicates SCell dormancy by reinterpreting a predefined set of fields associated with a first serving cell in the first set of serving cells, and HARQ-ACK information bits corresponding to the first DCI format are ordered based on serving cell indexes of the at least one serving cell and the first serving cell.

In some embodiments, the first serving cell is a serving cell with a predefined cell index among cell(s) having invalid frequency domain resource assignment (FDRA) value(s) in the first DCI format among the first set of serving cells.

In some embodiments, each of the second set of DCI formats is received at a different serving cell, or the second set of DCI formats is received at the same serving cell, or one or more DCI formats of the second set of DCI formats are received at the same serving cell and each of the remaining DCI formats of the second set of DCI formats is received at a different serving cell.

Some embodiments of the present disclosure provide a base station (BS). The BS may include at least one memory; and at least one processor coupled with the at least one memory and configured to cause the BS to: transmit signaling for configuring a plurality of sets of serving cells for multi-cell scheduling; transmit a first set of DCI formats with each DCI format scheduling a single PDSCH, or not scheduling any PDSCH with required HARQ-ACK feedback; transmit a second set of DCI formats with each DCI format scheduling more than one PDSCH, or scheduling one or more PDSCHs and indicating SCell dormancy, wherein each of the more than one PDSCH or the one or more PDSCHs is scheduled on a cell of a set of serving cells among the plurality of sets of serving cells; and receive a HARQ-ACK codebook including a first HARQ-ACK sub-codebook and a second HARQ-ACK sub-codebook, wherein the first HARQ-ACK sub-codebook includes HARQ-ACK information bits corresponding to the first set of DCI formats and the second HARQ-ACK sub-codebook includes HARQ-ACK information bits corresponding to the second set of DCI formats.

In some embodiments, each DCI format of the first set of DCI formats includes a counter DAI indicating an accumulative number of pairs of a serving cell and a PDCCH monitoring occasion in which a PDSCH transmission with HARQ-ACK feedback enabled or a DCI format with HARQ-ACK feedback required is present, up to a current serving cell and a current PDCCH monitoring occasion.

In some embodiments, counter DAIs of the first set of DCI formats are updated first according to a predefined order of serving cell indexes and then according to a predefined order of PDCCH monitoring occasion indexes.

In some embodiments, in the case that the first set of DCI formats includes at least two DCI formats in a same PDCCH monitoring occasion scheduling respective PDSCHs on a same serving cell, counter DAIs of the at least two DCI formats are updated according to a predefined order of start times for transmitting the respective PDSCHs.

In some embodiments, the HARQ-ACK information bits in the first HARQ-ACK sub-codebook are ordered based on counter DAIs of the first set of DCI formats.

In some embodiments, the second HARQ-ACK sub-codebook includes one or more parts, each of which corresponds to a set of serving cells scheduled by the second set of DCI formats among the plurality of sets of serving cells. The one or more parts are ordered based on set indexes of sets of serving cells scheduled by the second set of DCI formats.

In some embodiments, a first DCI format of the second set of DCI formats schedules a serving cell in a first set of serving cells among the plurality of sets of serving cells and a number of HARQ-ACK information bits corresponding to the first DCI format depends on a maximum number of HARQ-ACK information bits per DCI format among DCI formats scheduling the first set of serving cells.

In some embodiments, a first DCI format of the second set of DCI formats schedules a serving cell in a first set of serving cells among the plurality of sets of serving cells, and wherein the first DCI format includes a counter DAI indicating an accumulative number of pairs of a serving cell with a smallest serving cell index among more than one scheduled serving cells and PDCCH monitoring occasion in which PDSCH transmissions are present, up to current more than one scheduled serving cells in the first set of serving cells and a current PDCCH monitoring occasion.

In some embodiments, each DCI format of the second set of DCI formats includes a counter DAI and wherein counter DAIs of DCI formats scheduling different sets of serving cells in the second set of DCI formats are counted separately. In some embodiments, HARQ-ACK information bits in each part of the one or more parts are ordered based on counter DAI(s) of DCI format(s) scheduling a corresponding set of serving cells in the second set of DCI formats.

In some embodiments, each DCI format of the second set of DCI formats includes a counter DAI which is counted among all DCI formats of the second set of DCI formats. In some embodiments, the HARQ-ACK information bits corresponding to the second set of DCI formats in the second HARQ-ACK sub-codebook are ordered based on counter DAI(s) of the second set of DCI formats.

In some embodiments, a first DCI format of the second set of DCI formats schedules a serving cell in a first set of serving cells among the plurality of sets of serving cells and a number of HARQ-ACK information bits corresponding to the first DCI format depends on that of a DCI format having a maximum number of HARQ-ACK information bits among the second set of DCI formats.

In some embodiments, the first DCI format includes a counter DAI indicating an accumulative number of pairs of a serving cell with a smallest serving cell index among more than one scheduled serving cells and PDCCH monitoring occasion in which PDSCH transmissions are present, up to current more than one scheduled serving cells and a current PDCCH monitoring occasion.

In some embodiments, the counter DAI is updated first according to a predefined order of the smallest serving cell index among the more than one scheduled serving cells and then according to a predefined order of PDCCH monitoring occasion index.

In some embodiments, in the case that the second set of DCI formats includes at least two DCI formats in a same PDCCH monitoring occasion and the at least two DCI formats schedule respective PDSCHs on a same serving cell having the smallest serving cell index among respective serving cells scheduled by the at least two DCI formats, counter DAIs of the at least two DCI formats are updated according to a predefined order of start times for transmitting the respective PDSCHs.

In some embodiments, the first DCI format schedules a plurality of serving cells in the first set of serving cells, and wherein the current more than one scheduled serving cells include the plurality of serving cells and the PDSCH transmissions include PDSCH transmissions on the plurality of serving cells.

In some embodiments, the first DCI format schedules at least one serving cell in the first set of serving cells and indicates SCell dormancy by reinterpreting a predefined set of fields associated with a first serving cell in the first set of serving cells, and wherein the current more than one scheduled serving cells include the at least one serving cell and the first serving cell and the PDSCH transmissions include PDSCH transmission(s) on the at least one serving cell and a virtual PDSCH transmission on the first serving cell.

In some embodiments, a first DCI format of the second set of DCI formats schedules a plurality of serving cells in a first set of serving cells, and HARQ-ACK information bits corresponding to the first DCI format are ordered based on serving cell indexes of the plurality of serving cells.

In some embodiments, a first DCI format schedules at least one serving cell in a first set of serving cells and indicates SCell dormancy by reinterpreting a predefined set of fields associated with a first serving cell in the first set of serving cells, and HARQ-ACK information bits corresponding to the first DCI format are ordered based on serving cell indexes of the at least one serving cell and the first serving cell.

In some embodiments, the first serving cell is a serving cell with a predefined cell index among cell(s) having invalid FDRA value(s) in the first DCI format among the first set of serving cells.

In some embodiments, each of the second set of DCI formats is transmitted at a different serving cell, or the second set of DCI formats is transmitted at the same serving cell, or one or more DCI formats of the second set of DCI formats are transmitted at the same serving cell and each of the remaining DCI formats of the second set of DCI formats is transmitted at a different serving cell.

Some embodiments of the present disclosure provide a processor. The processor may include at least one controller coupled with at least one memory and configured to cause the processor to: receive signaling for configuring a plurality of sets of serving cells for multi-cell scheduling; receive a first set of DCI formats with each DCI format scheduling a single PDSCH, or not scheduling any PDSCH with required HARQ-ACK feedback; receive a second set of DCI formats with each DCI format scheduling more than one PDSCH, or scheduling one or more PDSCHs and indicating SCell dormancy, wherein each of the more than one PDSCH or the one or more PDSCHs is scheduled on a cell of a set of serving cells among the plurality of sets of serving cells; generate a first HARQ-ACK sub-codebook including HARQ-ACK information bits corresponding to the first set of DCI formats; generate a second HARQ-ACK sub-codebook including HARQ-ACK information bits corresponding to the second set of DCI formats; and transmit a HARQ-ACK codebook including the first HARQ-ACK sub-codebook and the second HARQ-ACK sub-codebook.

Some embodiments of the present disclosure provide a processor. The processor may include at least one controller coupled with at least one memory and configured to cause the processor to: transmit signaling for configuring a plurality of sets of serving cells for multi-cell scheduling; transmit a first set of DCI formats with each DCI format scheduling a single PDSCH, or not scheduling any PDSCH with required HARQ-ACK feedback; transmit a second set of DCI formats with each DCI format scheduling more than one PDSCH, or scheduling one or more PDSCHs and indicating SCell dormancy, wherein each of the more than one PDSCH or the one or more PDSCHs is scheduled on a cell of a set of serving cells among the plurality of sets of serving cells; and receive a HARQ-ACK codebook including a first HARQ-ACK sub-codebook and a second HARQ-ACK sub-codebook, wherein the first HARQ-ACK sub-codebook includes HARQ-ACK information bits corresponding to the first set of DCI formats and the second HARQ-ACK sub-codebook includes HARQ-ACK information bits corresponding to the second set of DCI formats.

Some embodiments of the present disclosure provide a method for wireless communication. The method may include: receiving signaling for configuring a plurality of sets of serving cells for multi-cell scheduling; receiving a first set of DCI formats with each DCI format scheduling a single PDSCH, or not scheduling any PDSCH with required HARQ-ACK feedback; receiving a second set of DCI formats with each DCI format scheduling more than one PDSCH, or scheduling one or more PDSCHs and indicating SCell dormancy, wherein each of the more than one PDSCH or the one or more PDSCHs is scheduled on a cell of a set of serving cells among the plurality of sets of serving cells; generating a first HARQ-ACK sub-codebook including HARQ-ACK information bits corresponding to the first set of DCI formats; generating a second HARQ-ACK sub-codebook including HARQ-ACK information bits corresponding to the second set of DCI formats; and transmitting a HARQ-ACK codebook including the first HARQ-ACK sub-codebook and the second HARQ-ACK sub-codebook.

Some embodiments of the present disclosure provide a method for wireless communication. The method may include: transmitting signaling for configuring a plurality of sets of serving cells for multi-cell scheduling; transmitting a first set of DCI formats with each DCI format scheduling a single PDSCH, or not scheduling any PDSCH with required HARQ-ACK feedback; transmitting a second set of DCI formats with each DCI format scheduling more than one PDSCH, or scheduling one or more PDSCHs and indicating SCell dormancy, wherein each of the more than one PDSCH or the one or more PDSCHs is scheduled on a cell of a set of serving cells among the plurality of sets of serving cells; and receiving a HARQ-ACK codebook including a first HARQ-ACK sub-codebook and a second HARQ-ACK sub-codebook, wherein the first HARQ-ACK sub-codebook includes HARQ-ACK information bits corresponding to the first set of DCI formats and the second HARQ-ACK sub-codebook includes HARQ-ACK information bits corresponding to the second set of DCI formats.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of a DCI format scheduling a plurality of PDSCHs in accordance with some embodiments of the present disclosure;

FIGS. 3 and 4 illustrate schematic diagrams of a plurality of DCI formats scheduling a plurality of PDSCHs in accordance with some embodiments of the present disclosure;

FIGS. 5 and 6 illustrate schematic diagrams of HARQ-ACK codebook determination in accordance with some embodiments of the present disclosure;

FIGS. 7 and 8 illustrate flowcharts of wireless communication methods in accordance with some embodiments of the present disclosure;

FIG. 9 illustrates an example of a UE in accordance with some embodiments of the present disclosure;

FIG. 10 illustrates an example of a processor in accordance with some embodiments of the present disclosure; and

FIG. 11 illustrates an example of a network equipment (NE) in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G NR or 6G, 3GPP LTE, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

To reduce control signaling overhead, it would be beneficial to use a single DCI format to schedule multiple PDSCHs or PUSCHs on multiple cells. A UE can be configured with one or multiple sets of cells with each set being configured for multi-cell scheduling. However, existing technologies do not provide any solutions for ordering HARQ-ACK information bits among HARQ-ACK information bits for multiple PDSCHs scheduled by each multi-cell scheduling DCI format when multiple sets of cells are configured for multi-cell scheduling. In addition, existing technologies do not provide any solutions for generating a Type-2 HARQ-ACK codebook when multiple sets of cells are configured for multi-cell scheduling.

The present disclosure provides various methods and apparatuses for HARQ-ACK codebook determination. The proposed solutions can address the above issues. For example, embodiments of the present disclosure provide solutions for generating and ordering HARQ-ACK information bit for multiple PDSCHs scheduled by each multi-cell scheduling DCI format when multiple sets of cells are configured for multi-cell scheduling.

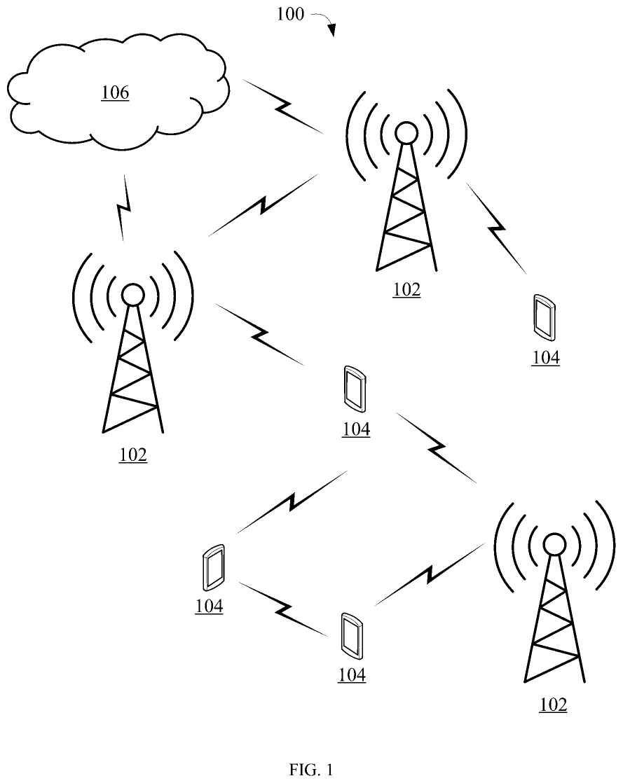

FIG. 1 illustrates a schematic diagram of wireless communication system 100 in accordance with some embodiments of the present disclosure.

The wireless communication system 100 may include one or more NEs 102 (e.g., one or more BSs), one or more UEs 104, and a core network (CN) 106. The wireless communication system 100 may support various radio access technologies. In some implementations, the wireless communication system 100 may be a 4G network, such as an LTE network or an LTE-Advanced (LTE-A) network. In some other implementations, the wireless communication system 100 may be a NR network, such as a 5G network, a 5G-Advanced (5G-A) network, or a 5G ultra-wideband (5G-UWB) network. In other implementations, the wireless communication system 100 may be a combination of a 4G network and a 5G network, or other suitable radio access technology including Institute of Electrical and Electronics Engineers (IEEE) 802.11 (Wi-Fi), IEEE 802.16 (WiMAX), and IEEE 802.20. The wireless communication system 100 may support radio access technologies beyond 5G, for example, 6G. Additionally, the wireless communication system 100 may support technologies, such as time division multiple access (TDMA), frequency division multiple access (FDMA), or code division multiple access (CDMA), etc.

The one or more NEs 102 may be dispersed throughout a geographic region to form the wireless communication system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with a different NE 102.

The one or more UEs 104 may be dispersed throughout a geographic region of the wireless communication system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communication with the CN 106, or with another NE 102, or both. For example, an NE 102 may interface with another NE 102 or the CN 106 through one or more backhaul links (e.g., S1, N2, N3 or another network interface). In some implementations, the NE 102 may communicate with each other directly. In some other implementations, the NE 102 may communicate with each other or indirectly (e.g., via the CN 106. In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management (AMF)) functions and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N3, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communication system 100, the NEs 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communication). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

In some embodiments, the NEs 102 may include one or more relay nodes, integrated access and backhaul (IAB) nodes or wireless access backhaul (WAB) nodes which can provide wireless access services for UEs 104. A relay node (or an IAB node or a WAB node) can directly connect to a BS or hop through one or more relay nodes (or one or more IAB or WAB nodes) before reaching the BS.

One or more numerologies may be supported in the wireless communication system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix. A sixth numerology (e.g., μ=5) may be associated with a sixth subcarrier spacing (e.g., 480 kHz) and a normal cyclic prefix. A seventh numerology (e.g., μ=6) may be associated with a seventh subcarrier spacing (e.g., 960 kHz) and a normal cyclic prefix. For ambient IoT communication, additional numerologies (e.g., μ=−1 or μ=−2) may be introduced corresponding to 7.5 kHz or 3.75 kHz respectively.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communication system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communication system 100, an electromagnetic (EM) spectrum may be split, based on frequency or wavelength, into various classes, frequency bands, frequency channels, etc. By way of example, the wireless communication system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHZ-114.25 GHz), FR4a or FR4-1 (52.6 GHZ-71 GHz), and FR5 (114.25 GHZ-300 GHz). In some implementations, the NEs 102 and the UEs 104 may perform wireless communication over one or more of the operating frequency bands. In some implementations, FR1 may be used by the NEs 102 and the UEs 104, among other equipment or devices for cellular communication traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A UE 104 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, a UE 104 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, a UE 104 includes wearable devices, such as smart watches, fitness bands, optical head-mounted displays, or the like. Moreover, a UE 104 may be referred to as a subscriber unit, a mobile, a mobile station, a user, a terminal, a mobile terminal, a wireless terminal, a fixed terminal, a subscriber station, a user terminal, or a device, or described using other terminology used in the art. A UE 104 may communicate with an NE 102 (e.g., a BS) via uplink (UL) communication signals. An NE 102 may communicate with a UE 104 via downlink (DL) communication signals.

In some embodiments of the present disclosure, an NE 102 and a UE 104 may communicate over licensed spectrums, whereas in some other embodiments, an NE 102 and a UE 104 may communicate over unlicensed spectrums. The present disclosure is not intended to be limited to the implementation of any particular wireless communication system architecture or protocol. Persons skilled in the art should understand that as technology develops and advances, the terminologies described in the present disclosure may change, but should not affect or limit the principles and spirit of the present disclosure.

In some embodiments of the present disclosure, the wireless communication system 100 may be designed to support carrier aggregation (CA). For example, the wireless communication system 100 may support a maximum of 16 component carriers (CCs) in the case of carrier aggregation (CA) or a maximum of 32 CCs in the case of dual connectivity (DC). In some embodiments of the present disclosure, to reduce signaling overhead, it would be beneficial to use a single DCI format to schedule multiple PDSCHs or PUSCHs on multiple cells (or carriers). In the context of the present disclosure, the term “cell” may be used interchangeably with the term “carrier.” For example, a set of cells which includes up to 4 cells can be configured for a UE by a BS via, for example, radio resource control (RRC) signaling. One DCI format can schedule one or multiple cells within the set of cells for DL transmission with one PDSCH per cell. For convenience, DCI format 1_3 is used in this disclosure as an example of such a DCI format. One DCI format can schedule one or multiple cells within the set of cells for UL transmission with one PUSCH per cell. For convenience, DCI format 0_3 is used in this disclosure as an example of such a DCI format.

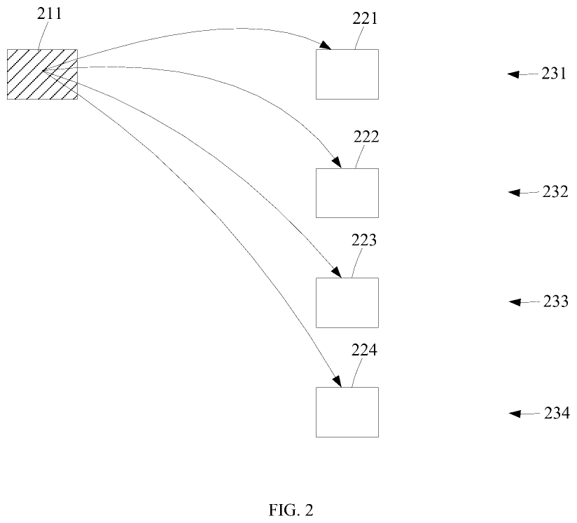

FIG. 2 illustrates a schematic diagram of a DCI format scheduling a plurality of PDSCHs in accordance with some embodiments of the present disclosure.

In some embodiments, a set of cells (e.g., including but not limited to CCs 231-234 in FIG. 2) may be configured for a UE by a BS via RRC signaling. In some embodiments, PDCCH monitoring on a DCI format (e.g., DCI format 1_3) for multi-cell scheduling may be configured on one cell (e.g., CC 231) of the set of cells. Each CC of the set of CCs may correspond to a respective cell (e.g., serving cell) or carrier of the UE. Each cell (serving cell) may be associated with a (serving) cell index. The sub-carrier spacing (SCS) of CCs 231-234 may be different or the same.

A BS may transmit a single DCI format to schedule a plurality of PDSCH on a plurality of cells. For example, as shown in FIG. 2, DCI format 211 on CC 231 may schedule a single PDSCH on each of CCs 231-234. For example, each of PDSCHs 221-224 may be scheduled on each of CCs 231-234.

In some embodiments of the present disclosure, a UE can be configured with one or multiple sets of cells and each set is configured for multi-cell scheduling using, for example, DCI format 0_3 or DCI format 1_3. In some embodiments, up to 4 sets of cells can be configured per a physical uplink control channel (PUCCH) group. In some embodiments, when multiple sets of cells are configured, one or more of the following requirements may be met: (1) a cell in one set of cells cannot be included in another set of cells; (2) n_CI value is independently configured for each set of cells (the definition of parameter “n_CI” can be found in 3GPP specifications); (3) reference cell for counting DCI size and blind detection (BD)/control channel element (CCE) of a multi-cell scheduling DCI format (e.g., DCI format 0_3 or DCI format 1_3) is independently determined for each set of cells; (4) search space configuration of DCI format 0_X or DCI format 1_X is independently configured for each set of cells; and (5) the DCI size of a multi-cell scheduling DCI format is independently determined for each set of cells, for example, DCI size of DCI format 0_3 is independently determined for each set of cells and DCI size of DCI format 1_3 is independently determined for each set of cells. DCI format 0_X may include, for example, DCI format 0_0, DCI format 0_1, DCI format 0_2, and DCI format 0_3. DCI format 1_X may include, for example, DCI format 1_0, DCI format 1_1, DCI format 1_2, and DCI format 1_3.

In the present disclosure, the multiple sets of cells for multi-cell scheduling can be configured in various ways. The following are some examples.

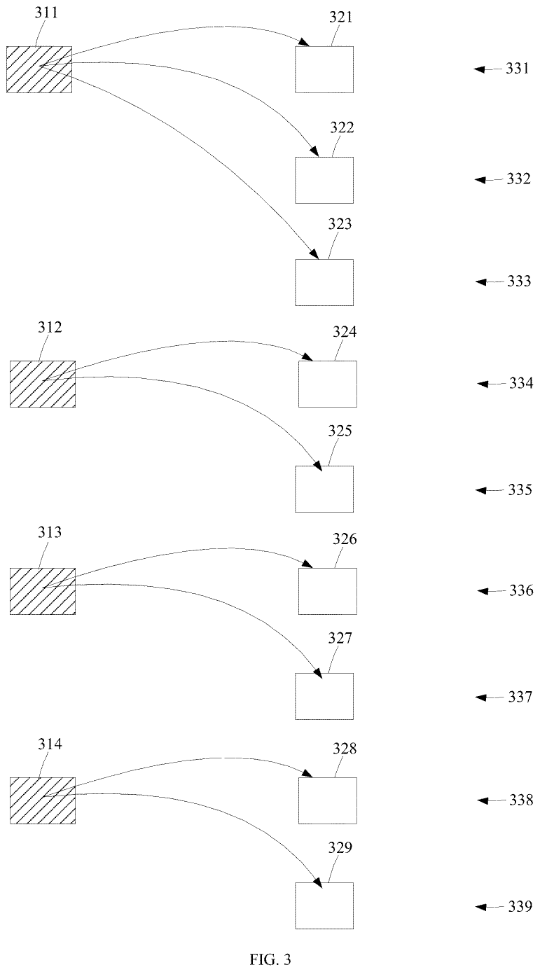

In some examples, the multiple sets of cells can be respectively scheduled by multi-cell scheduling DCI formats (e.g., DCI format 0_3 or DCI format 1_3) from different scheduling cells (denoted as “Case 1”). For example, referring to FIG. 3, a UE is configured with 4 sets of cells, wherein each set is configured for multi-cell scheduling using DCI format 1_3 or DCI format 0_3 and scheduled from a different scheduling cell. Denoting the 4 sets of cells as set #1 to set #4, set #1 includes CCs 331-333, set #2 includes CCs 334 and 335, set #3 includes CCs 336 and 337, and set #4 includes CCs 338 and 339. The scheduling cells for set #1 to set #4 are CC 331, CC 334, CC 336, and CC 338, respectively. As shown in FIG. 3, DCI format 311 on CC 331 may schedule each of PDSCHs 321-323 on each of CCs 331-333, DCI format 312 on CC 334 may schedule each of PDSCHs 324 and 325 on each of CCs 334 and 335, DCI format 313 on CC 336 may schedule each of PDSCHs 326 and 327 on each of CCs 336 and 337 and DCI format 314 on CC 338 may schedule each of PDSCHs 328 and 329 on each of CCs 338 and 339.

In some examples, up to a certain number (denoted as “N”) of sets of cells can be configured and respectively scheduled by multi-cell scheduling DCI formats (e.g., DCI format 0_3 or DCI format 1_3) from the same scheduling cell (denoted as “Case 2”). The value of N can be reported as UE capability. In some embodiments, the multi-cell scheduling DCI format (e.g., DCI format 0_3 or DCI format 1_3) may include an indicator indicating the scheduled set(s) of cells. The size of the indicator may be dependent on (e.g., equal to) ceil (log₂(N)). Unique n_CI value may be configured for each set of cells.

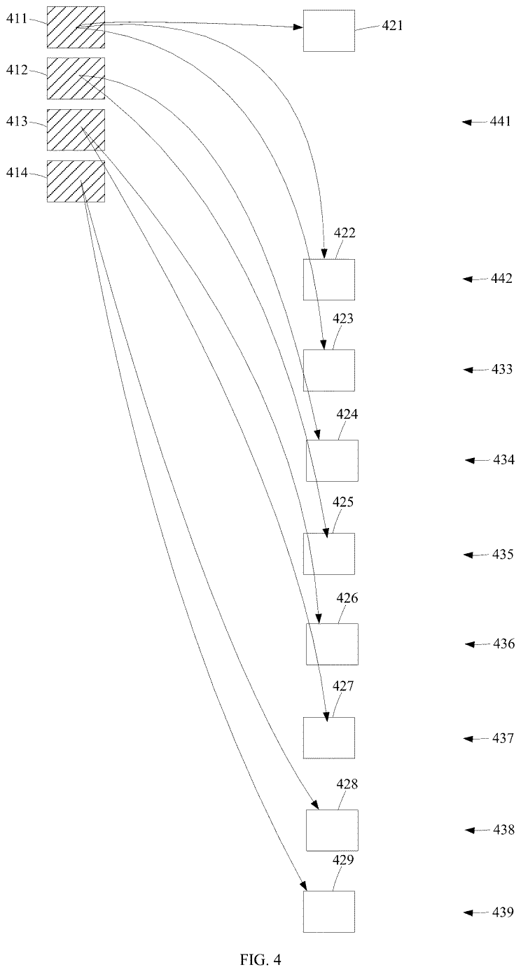

For example, referring to FIG. 4, a UE is configured with 4 sets of cells, wherein each set is configured for multi-cell scheduling using DCI format 1_3 or DCI format 0_3 and scheduled from a different scheduling cell. Denoting the 4 sets of cells as set #1′ to set #4′, set #1′ includes CCs 431-433, set #2′ includes CCs 434 and 435, set #3′ includes CCs 436 and 437, and set #4′ includes CCs 438 and 439. The scheduling cells for set #1′ to set #4′ are the same, i.e., CC 431. As shown in FIG. 4, DCI format 411 on CC 431 may schedule each of PDSCHs 421-423 on each of CCs 431-433, DCI format 412 on CC 431 may schedule each of PDSCHs 424 and 425 on each of CCs 434 and 435, DCI format 413 on CC 431 may schedule each of PDSCHs 426 and 427 on each of CCs 436 and 437 and DCI format 414 on CC 431 may schedule each of PDSCHs 428 and 429 on each of CCs 438 and 439.

Another case (denoted as “Case 3”) may be a combination of Case 1 and Case 2. For example, multiple sets of cells are configured with each set configured for multi-cell scheduling, where one or more sets of cells of the multiple sets of cells may be scheduled from the same scheduling cell while the remaining sets of cells may be respectively scheduled from different scheduling cells.

Embodiments of the present disclosure provide various methods for HARQ-ACK codebook determination. For example, when a UE is configured with multiple sets of cells with each set configured for multi-cell scheduling, one problem is how to determine the HARQ-ACK information bit ordering among HARQ-ACK information bits for multiple PDSCHs scheduled by each DCI format and how to generate HARQ-ACK codebook when a Type-2 (or dynamic) HARQ-ACK codebook is configured. Known Type-2 HARQ-ACK codebook generation does not consider the case where multiple sets of cells are configured, for example, as shown in FIGS. 3 and 4 where a UE is configured with 9 cells and 4 sets of cells. Embodiments of the present disclosure provide solutions for HARQ-ACK information bit generating and ordering for multiple PDSCHs scheduled by each multi-cell scheduling DCI format (e.g., DCI format 1_3). More details on the embodiments of the present disclosure will be illustrated in the following text in combination with the appended drawings.

In some embodiments of the present disclosure, when a plurality of sets of serving cells for multi-cell scheduling is configured, a HARQ-ACK codebook may include two HARQ-ACK sub-codebooks (denoted as “sub-codebook #1” and “sub-codebook #2”). The plurality of sets of serving cells for multi-cell scheduling may be configured in a manner described with respect to Case 1, Case 2, Case 3, or any other cases that can be conceived of by persons skilled in the art. In some embodiments, sub-codebook #1 may be placed in front of sub-codebook #2. In some embodiments, sub-codebook #2 may be placed in front of sub-codebook #1.

In some embodiments, sub-codebook #1 may include HARQ-ACK information bits corresponding to DCI formats satisfying certain criteria. For example, a DCI format associated with sub-codebook #1 may be a DCI format scheduling a single PDSCH or a DCI format not scheduling any PDSCH with required HARQ-ACK feedback.

For example, when a BS transmits a plurality of DCI formats to a UE and HARQ-ACK information bits corresponding to the plurality of DCI formats are to be transmitted in the same HARQ-ACK codebook, the HARQ-ACK codebook may include sub-codebook #1, which may include HARQ-ACK information bits corresponding to a set of DCI formats (denoted as DCI set #1) among the plurality of DCI formats. Each DCI format in DCI set #1 may schedule a single PDSCH or not schedule any PDSCH with required HARQ-ACK feedback. In other words, sub-codebook #1 may include HARQ-ACK information bits for PDSCH receptions scheduled by respective DCI formats with each DCI format scheduling one PDSCH or HARQ-ACK information bits for DCI formats without scheduling any PDSCH with required HARQ-ACK feedback.

For example, sub-codebook #1 may include HARQ-ACK information bits for PDSCHs respectively scheduled by DCI format 1_0, DCI format 1_1, DCI format 1_2or DCI format 1_3 scheduling one PDSCH, and HARQ-ACK information bits for a DCI format(s) which does not schedule any PDSCH and is transmitted for a DL semi-persistent scheduling (SPS) PDSCH release, transmission configuration indication (TCI) update, SCell dormancy indication or other purposes. For example, the DCI formats associated with sub-codebook #1 (i.e., DCI formats in DCI set #1) may include DCI format 1_0, DCI format 1_1, DCI format 1_2 and DCI format 1_3, each of which scheduling a single PDSCH, and DCI format 1_0, DCI format 1_1, DCI format 1_2 and DCI format 1_3, each of which indicating a DL SPS release, a TCI update, SCell dormancy or other purposes without scheduling any PDSCH.

In some embodiments, a single HARQ-ACK information bit may be generated in sub-codebook #1 for each DCI format associated with sub-codebook #1. For example, a respective HARQ-ACK information bit may be generated for each DCI format in DCI set #1. Sub-codebook #1 may include the HARQ-ACK information bits corresponding to DCI set #1.

In some embodiments, each DCI format in DCI set #1 may include a counter DAI. The counter DAI counting is performed among all the DCI formats in DCI set #1. The HARQ-ACK information bits in sub-codebook #1 can be ordered based on the counter DAIs of the DCI formats in DCI set #1, for example, based on a predefined order (e.g., an ascending or descending order) of the counter DAIs.

In some embodiments, the counter DAI may denote the accumulative number of {serving cell, PDCCH monitoring occasion}-pairs in which a PDSCH reception with HARQ-ACK feedback enabled or a DCI format with HARQ-ACK feedback required is present, up to the current serving cell and the current PDCCH monitoring occasion. A PDSCH reception with HARQ-ACK feedback enabled can refer to a PDSCH reception that provides transport blocks (TBs) with enabled HARQ-ACK information report. A DCI format with HARQ-ACK feedback required can refer to a DCI format not scheduling any PDSCH but requiring HARQ-ACK feedback for itself, and thus can be regarded as a DCI format scheduling a single (virtual) PDSCH. For example, DCI format with HARQ-ACK feedback required may be a DCI format indicating DL SPS release, a TCI update, or SCell dormancy. In some examples, a DCI format for SPS activation does not require HARQ-ACK feedback and thus is not a DCI format with HARQ-ACK feedback required.

In some embodiments, the counter DAIs may be updated (e.g., incremented) according to a certain rule. For example, the counter DAIs may be updated first according to a predefined order (e.g., an ascending or descending order) of serving cell indexes and then according to a predefined order (e.g., an ascending or descending order) of PDCCH monitoring occasion indexes.

In some embodiments, a UE may support more than one PDSCH reception on a serving cell that are scheduled from the same PDCCH monitoring occasion (e.g., indicated by “type 2-HARQ-ACK-Codebook” as defined in 3GPP specification). The counter DAIs may be firstly updated in a predefined order (e.g., an increasing or decreasing order) of the PDSCH reception start times for the same {serving cell, PDCCH monitoring occasion} pair, secondly in a predefined order (e.g., an ascending or descending order) of serving cell indexes, and thirdly in a predefined order (e.g., an ascending or descending order) of PDCCH monitoring occasion indexes. For example, DCI set #1 may include at least two DCI formats in the same PDCCH monitoring occasion scheduling respective PDSCHs on the same serving cell. In such a case, counter DAIs of the at least two DCI formats can be updated according to a predefined order (e.g., an increasing or decreasing order) of start times for receiving the respective PDSCHs.

In some embodiments, sub-codebook #2 may include HARQ-ACK information bits corresponding to the remaining DCI formats that are not associated with sub-codebook #1 in the plurality of DCI formats with corresponding HARQ-ACK information bits to be transmitted in the same HARQ-ACK codebook may be DCI formats associated with sub-codebook #2. For example, a DCI format associated with sub-codebook #2 may be a DCI format scheduling more than one PDSCH, or a DCI format scheduling one or more PDSCHs and indicating SCell dormancy. Each of the more than one PDSCH or the one or more PDSCHs is scheduled on a cell of a set of serving cells among the plurality of sets of serving cells configured for multi-cell scheduling.

For example, when a BS transmits a plurality of DCI formats to a UE and HARQ-ACK information bits corresponding to the plurality of DCI formats are to be transmitted in the same HARQ-ACK codebook, the HARQ-ACK codebook may include sub-codebook #2, which may include HARQ-ACK information bits corresponding to a set of DCI formats (denoted as DCI set #2) among the plurality of DCI formats. Each DCI format in DCI set #1 may schedule more than one PDSCH, or schedule one or more PDSCHs and indicating SCell dormancy. In other words, sub-codebook #2 may include HARQ-ACK information bits for PDSCH receptions scheduled by respective DCI formats (e.g., DCI formats 1_3) with each DCI format scheduling more than one PDSCH or scheduling one or more PDSCHs and indicating SCell dormancy.

For example, sub-codebook #2 may include (1) HARQ-ACK information bits for PDSCHs respectively scheduled by one or more DCI formats 1_3, with each DCI format 1_3 scheduling more than one PDSCH, (2) HARQ-ACK information bits for one or more PDSCHs scheduled by a DCI format 1_3 (denoted as DCI #1), and (3) a HARQ-ACK information bit for SCell dormancy indication, where DCI #1 schedules the one or more PDSCHs and indicates SCell dormancy.

Various methods can be employed to generate sub-codebook #2. In some embodiments, sub-codebook #2 can be divided into one or more parts, each of which corresponds to a respective set of serving cells. In some embodiments, sub-codebook #2 may include a single part. Example methods for determining or generating sub-codebook #2 will be described in detail below.

In some embodiments of the present disclosure, sub-codebook #2 may include one or more parts (e.g., M parts). Each of the M parts corresponds to a set of serving cells scheduled by DCI set #2 among the plurality of sets of serving cells configured for multi-cell scheduling. The M parts may be ordered based on set indexes of sets of serving cells scheduled by DCI set #2.

For example, assuming that 4 set of serving cells (denotes as cell sets #A1- #A4) are configured and DCI set #2 includes three DCI formats respective schedule cell sets #A1-#A3, sub-codebook #2 may include three parts corresponding to cell sets #A1-#A3. The three parts in sub-codebook #2 may be ordered according to set indexes of cell sets #A1-#A3. For example, HARQ-ACK information bits for thethree parts may be concatenated in an ascending or descending order of set indexes. In some examples, DCI set #2 includes three DCI formats with two DCI formats scheduling cell set #Al and the remaining one DCI format scheduling cell set #A2, sub-codebook #2 may include two parts corresponding to cell sets #Al and #A2. The two parts in sub-codebook #2 may be ordered according to set indexes of cell sets #A1 and #A2. As will be described in detail later, HARQ-ACK feedback corresponding to DCI formats (e.g., the two DCI formats scheduling cell set #A1) in the same part may be ordered based on counter DAIs of these DCI formats. Methods for ordering HARQ-ACK information bits corresponding to one DCI format (e.g., each of the two DCI formats scheduling cell set #A1) in DCI set #2 will also be described in detail later.

In the context of the present disclosure, it should be noted that a DCI format scheduling a set of cells does not necessarily mean that this DCI format scheduling all cells in the set of cells, but can include this DCI format scheduling one or more cells in the set of cells, or this DCI format not scheduling any cells in the set of cells but indicating certain information (e.g., indicating SCell dormancy or the like) with respect to at least one cell in the set of cells, or this DCI format scheduling one or more cells in the set of cells and indicating certain information with respect to at least one cell in the set of cells.

In some embodiments, the number of HARQ-ACK information bits corresponding to a DCI format (denoted as DCI #2) in DCI set #2 may be dependent on a maximum number of HARQ-ACK information bits per DCI format among DCI formats scheduling the same set of serving cells as DCI #2. For example, assuming that cell set #B includes cells #B1-#B3 and DCI #2 schedules two PDSCHs on cells #B1 and #B2 of cell set #B, the number of HARQ-ACK information bits corresponding to DCI #2 is dependent on a maximum number of HARQ-ACK information bits per DCI format among DCI formats scheduling cell set #B, for example, dependent on the number of HARQ-ACK information bits corresponding to a DCI format scheduling all cells in cell set #B (e.g., scheduling respective PDSCHs on cells #B1-#B3). Therefore, in some cases, different parts of the M parts may include different numbers of HARQ-ACK information bits.

In some embodiments, each DCI format in DCI set #2 may include a counter DAI. The counter DAI counting is performed separately for each set of cells. In other words, counter DAIs of DCI formats scheduling different sets of serving cells in DCI set #2 are counted separately. The HARQ-ACK information bits in each part of the M parts in sub-codebook #2 can be ordered based on (e.g., in an ascending or descending order of) the counter DAI(s) of corresponding DCI format(s).

For example, assuming that DCI set #2 includes DCI #C1 to DCI #C4, DCI #Cl and DCI #C3 schedule cell set #C1 and DCI #C2 and DCI #C4 schedule cell set #C2, then counter DAIs of DCI #C1 and DCI #C3 are counted separately from those of DCI #C2 and DCI #C4. Sub-codebook #2 includes part #C1 corresponding to cell set #C1 and part #C2 corresponding to cell set #C2. HARQ-ACK information bits in part #C1 may be generated in an ascending order of counter DAIs of DCI #C1 and DCI #C3. HARQ-ACK information bits in part #C2 may be generated in an ascending order of counter DAIs of DCI #C2 and DCI #C4.

In some embodiments, the counter DAI of a DCI format in DCI set #2 may denote the accumulative number of {serving cell with the smallest index from more than one scheduled serving cell, PDCCH monitoring occasion}-pairs in which PDSCH receptions are present, up to the current more than one scheduled serving cell within the current set of cells and current PDCCH monitoring occasion.

“More than one scheduled serving cell” in the above definition of counter DAI can refer to (1) one or more serving cells that are actually scheduled by the DCI format (e.g., the DCI schedules a PDSCH on each of the one or more serving cells); or (2) at least one serving cell that is actually scheduled by the DCI format and a serving cell “virtually” scheduled by the DCI format (e.g., the DCI format “virtually” schedules a PDSCH on this serving cell or the DCI format schedules a “virtual” PDSCH on this serving cell).

For example, a DCI format (denotes as DCI #3) may schedule at least one serving cell in cell set #D and indicate SCell dormancy by reinterpreting a predefined set of DCI fields associated with a certain serving cell (denoted as cell #D) in cell set #D. Cell #D can be referred to as a serving cell “virtually” scheduled by DCI #3. In other words, a “virtual” PDSCH is scheduled on cell #D by DCI #3. For example, cell #D may be a serving cell having a corresponding invalid FDRA value in DCI #3. For example, cell #D may be a serving cell with a predefined cell index (e.g., smallest cell index) among cells having corresponding invalid FDRA values in DCI #3. Therefore, a DCI format schedules at least one serving cell and indicates SCell dormancy can be regarded as a DCI format schedules more than one serving cells or more than one PDSCHs.

In some embodiments, for resource allocation Type 0, if all bits of the FDRA field for a cell in a DCI format (e.g., DCI format 1_3) are equal to 0, then this cell is indicated with an invalid FDRA value; otherwise, the cell is indicated with a valid FDRA value. For resource allocation Type 1, if all bits of the FDRA field for a cell in a DCI format (e.g., DCI format 1_3) are equal to 1, then this cell is indicated with an invalid FDRA value; otherwise, the cell is indicated with a valid FDRA value. For dynamic resource allocation switch between resource allocation Type 0 and resource allocation Type 1, if all bits of the FDRA field for a cell in a DCI format (e.g., DCI format 1_3) are equal to 0 or 1, then this cell is indicated with an invalid FDRA value; otherwise, the cell is indicated with a valid FDRA value.

In some embodiments, the counter DAIs may be updated (e.g., incremented) according to a certain rule. For example, the counter DAIs may be updated first according to a predefined order (e.g., an ascending or descending order) of the smallest serving cell index from the more than one scheduled serving cell and then according to a predefined order (e.g., an ascending or descending order) of PDCCH monitoring occasion indexes.

In some embodiments, a UE may support more than one PDSCH reception on a serving cell that are scheduled from the same PDCCH monitoring occasion (e.g., indicated by “type 2-HARQ-ACK-Codebook” as defined in 3GPP specification). The counter DAIs may be firstly updated in a predefined order (e.g., an increasing or decreasing order) of the PDSCH reception start times for the same {serving cell with the smallest index from the more than one scheduled serving cell, PDCCH monitoring occasion} pair, secondly in a predefined order (e.g., an ascending or descending order) of the smallest serving cell index from the more than scheduled one serving cell, and thirdly in a predefined order (e.g., an ascending or descending order) of PDCCH monitoring occasion indexes.

For example, DCI set #2 may include at least two DCI formats in the same PDCCH monitoring occasion and the at least two DCI formats schedule respective PDSCHs on the same serving cell having the smallest serving cell index among respective serving cells scheduled by the at least two DCI formats. In such a case, counter DAIs of the at least two DCI formats can be updated according to a predefined order (e.g., an increasing or decreasing order) of start times for receiving the respective PDSCHs. Here, the serving cells scheduled by a DCI format may include a serving cell actually scheduled by the DCI format (e.g., the DCI schedules a PDSCH thereon) and a serving cell “virtually” scheduled by the DCI format (e.g., the DCI “virtually” schedules a PDSCH thereon).

For example, a UE detects two DCI formats in a PDCCH monitoring occasion, one of the two DCI formats schedules a PDSCH on cell #A at time T1 and a PDSCH on cell #B at time T2 and the serving cell index of cell #A is smaller than that of cell #B, and the other DCI format schedules a PDSCH on cell #A at time T3 and a PDSCH on cell #C at time T4 and the serving cell index of cell #A is smaller than that of cell #C. The counter DAIs of the two DCI formats can be updated according to an increasing order of the start times (e.g., T1 and T3) for receiving respective PDSCHs on cell #A.

Various methods may be employed for ordering HARQ-ACK information bits corresponding to one DCI format in DCI set #2.

For example, a DCI format (denotes as DCI #4) may schedule a plurality of PDSCHs on a plurality of serving cells in a set of serving cells for multi-cell scheduling. HARQ-ACK information bits corresponding to DCI #4 may include HARQ-ACK information bits for the plurality of PDSCHs and can be ordered based on (e.g., in an ascending or descending order of) associated serving cell indexes of the plurality of serving cells.

For example, referring to FIG. 3, HARQ-ACK information bits corresponding to DCI format 311 may include HARQ-ACK information bits for PDSCHs 321-323 and can be ordered in an ascending order of CCs 331-333. For example, assuming that the serving cell indexes of CCs 331-333 satisfy CC 331<CC 332<CC 333, bl is the HARQ-ACK information bit for PDSCH 321, b2 is the HARQ-ACK information bit for PDSCH 322, and b3 is the HARQ-ACK information bit for PDSCH 323, HARQ-ACK information bits corresponding to DCI format 311 may be {b1, b2, b3}.

For example, a DCI format (denotes as DCI #5) may schedule at least one PDSCH on at least one serving cell in a set of serving cells for multi-cell scheduling and indicate SCell dormancy for a certain serving cell (e.g., cell #E). DCI #5 can be regarded as scheduling the at least one serving cell and cell #E. That is, DCI #5 can be regarded as scheduling the at least one PDSCH on the at least one serving cell and a virtual PDSCH on cell #E. In some examples, the virtual PDSCH is assumed to provide one TB which has been correctly decoded by the UE, and an “ACK” bit can be generated for the virtual PDSCH. HARQ-ACK information bit(s) for an actually scheduled PDSCH may depend on the decoding result of the PDSCH at a UE. HARQ-ACK information bits corresponding to DCI #5 may include HARQ-ACK information bits for the virtual PDSCH and the actually scheduled PDSCH(s), and can be ordered based on (e.g., in an ascending or descending order of) associated serving cell indexes among the at least one (actually scheduled) serving cell and (virtually scheduled) cell #E.

As described above, SCell dormancy indication in a DCI format may be achieved by reinterpreting a predefined set of DCI fields. For example, in the case that the value of one FDRA field in DCI #5 corresponding to a certain cell is set to be invalid, this cell is cell #E. For example, in the case that the values of a plurality of FDRA fields in DCI #5 corresponding to a plurality of cells are set to be invalid, cell #E may be the cell with a predefined cell index (e.g., smallest cell index) among the plurality of cells.

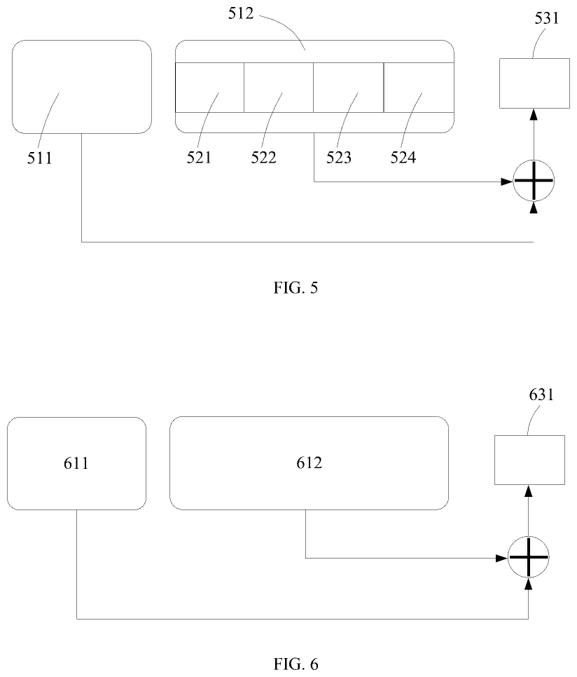

Referring to FIG. 5, a HARQ-ACK codebook may include sub-codebook 511 and sub-codebook 512 and may be transmitted at PUCCH 531. Sub-codebook 511 may be an instance of the aforementioned sub-codebook #1. Sub-codebook 512 may be an instance of the aforementioned sub-codebook #2. For example, sub-codebook 511 may include HARQ-ACK information bits corresponding to DCI formats each having a single HARQ-ACK information bit. For example, sub-codebook 512 may include HARQ-ACK information bits corresponding to DCI formats 1_3 each having more than one HARQ-ACK information bit. Sub-codebook 512 may be generated by concatenating HARQ-ACK information bits for each scheduled set of cells. For example, each of parts 521 to 524 may correspond to a scheduled set of cells configured for multi-cell scheduling.

In some embodiments of the present disclosure, sub-codebook #2 may not be divided into one or more parts corresponding to one or more scheduled sets of cells. The UE may generate a plurality of HARQ-ACK information bits corresponding to each DCI format in DCI set #2 and sub-codebook #2 may include HARQ-ACK information bits corresponding to DCI set #2 ordered based on a certain rule (e.g., counter DAIs of DCI formats in DCI set #2), which will be described in detail later. Methods for ordering HARQ-ACK information bits corresponding to one DCI format in DCI set #2 will also be described in detail later.

In some embodiments, the number of HARQ-ACK information bits corresponding to each DCI format in DCI set #2 may be dependent on the maximum number of HARQ-ACK information bits per DCI format among all the DCI formats in the same PUCCH group. For example, the number of HARQ-ACK information bits corresponding to each DCI format in DCI set #2 may be dependent on that of a DCI format having a maximum number of HARQ-ACK information bits among all the DCI formats in DCI set #2.

In some embodiments, each DCI format in DCI set #2 may include a counter DAI. The counter DAI counting is performed among all DCI formats in DCI set #2. For example, counter DAI counting is performed among all DCI formats 1_3 with each DCI format 1_3 scheduling more than one PDSCH or scheduling one or more PDSCHs and indicating SCell dormancy. The HARQ-ACK information bits corresponding to DCI set #2 in sub-codebook #2 can be ordered based on (e.g., in an ascending or descending order of) the counter DAI(s) of DCI set #2.

For example, assuming that DCI set #2 includes DCI #D1 to DCI #D3, the counter DAIs of DCI #D1 to DCI #D3 are counted together and are assumed to have values of 1 to 3, respectively. Sub-codebook #2 includes HARQ-ACK information bits corresponding to DCI #D1 to DCI #D3, which are ordered in an ascending order of counter DAIs of DCI #D1 to DCI #D3. For example, assuming that {a1, a2} are the HARQ-ACK information bits corresponding to DCI #D1, {a3, a4} are the HARQ-ACK information bits corresponding to DCI #D2, and {a5, a6, a7} are the HARQ-ACK information bits corresponding to DCI #D3, HARQ-ACK information bits in sub-codebook #2 may be ordered as {a1, a2, negative ACK (NACK) bit for padding (if any), a3, a4, NACK bit for padding (if any), a5, a6, a7}.

In some embodiments, the counter DAI of a DCI format in DCI set #2 may denote the accumulative number of {serving cell with the smallest index from more than one scheduled serving cell, PDCCH monitoring occasion}-pairs in which PDSCH receptions are present, up to the current more than one scheduled serving cell and current PDCCH monitoring occasion.

“More than one scheduled serving cell” in the above definition of counter DAI can refer to (1) one or more serving cells that are actually scheduled by the DCI format (e.g., the DCI schedules a PDSCH on each of the one or more serving cells); or (2) at least one serving cell that is actually scheduled by the DCI format and a serving cell “virtually” scheduled by the DCI format (e.g., the DCI format “virtually” schedules a PDSCH on this serving cell or the DCI format schedules a “virtual” PDSCH on this serving cell).

For example, a DCI format (denotes as DCI #6) may schedule at least one serving cell in cell set #F and indicate SCell dormancy by reinterpreting a predefined set of DCI fields associated with a certain serving cell (denoted as cell #F) in cell set #F. Cell #F is the serving cell “virtually” scheduled by DCI #6. In other words, a “virtual” PDSCH is scheduled on cell #F by DCI #6. For example, cell #F may be a serving cell having a corresponding invalid FDRA value in DCI #6. For example, cell #F may be a serving cell with a predefined cell index (e.g., smallest cell index) among cells having corresponding invalid FDRA values in DCI #6. Therefore, a DCI format schedules at least one serving cell and indicates SCell dormancy can be regarded as a DCI format schedules more than one serving cells or more than one PDSCHs.

In some embodiments, the counter DAIs may be updated (e.g., incremented) according to a certain rule. For example, the counter DAIs may be updated first according to a predefined order (e.g., an ascending or descending order) of the smallest serving cell index from the more than one scheduled serving cell and then according to a predefined order (e.g., an ascending or descending order) of PDCCH monitoring occasion indexes.

In some embodiments, a UE may support more than one PDSCH reception on a serving cell that are scheduled from the same PDCCH monitoring occasion (e.g., indicated by “type 2-HARQ-ACK-Codebook” as defined in 3GPP specification). The counter DAIs may be firstly updated in a predefined order (e.g., an increasing or decreasing order) of the PDSCH reception start times for the same {serving cell with the smallest index from the more than one scheduled serving cell, PDCCH monitoring occasion} pair, secondly in a predefined order (e.g., an ascending or descending order) of the smallest serving cell index from the more than scheduled one serving cell, and thirdly in a predefined order (e.g., an ascending or descending order) of PDCCH monitoring occasion indexes.

For example, DCI set #2 may include at least two DCI formats in the same PDCCH monitoring occasion and the at least two DCI formats schedule respective PDSCHs on the same serving cell having the smallest serving cell index among respective serving cells scheduled by the at least two DCI formats. In such a case, counter DAIs of the at least two DCI formats can be updated according to a predefined order (e.g., an increasing or decreasing order) of start times for receiving the respective PDSCHs. Here, the serving cells scheduled by a DCI format may include a serving cell actually scheduled by the DCI format (e.g., the DCI schedules a PDSCH thereon) and a serving cell “virtually” scheduled by the DCI format (e.g., the DCI “virtually” schedules a PDSCH thereon).

Various methods may be employed for ordering HARQ-ACK information bits corresponding to one DCI format in DCI set #2.

For example, a DCI format (denotes as DCI #7) may schedule a plurality of PDSCHs on a plurality of serving cells in a set of serving cells for multi-cell scheduling. HARQ-ACK information bits corresponding to DCI #7 may include HARQ-ACK information bits for the plurality of PDSCHs and can be ordered based on (e.g., in an ascending or descending order of) associated serving cell indexes of the plurality of serving cells.

For example, referring to FIG. 3, HARQ-ACK information bits corresponding to DCI format 312 may include HARQ-ACK information bits for PDSCHs 324 and 325 and can be ordered in an ascending order of CCs 334 and 335. For example, assuming that the serving cell indexes of CCs 334 and 335 satisfy CC 334<CC 335, c1 is the HARQ-ACK information bit for PDSCH 324 and c2 is the HARQ-ACK information bit for PDSCH 325, HARQ-ACK information bits corresponding to DCI format 312 may be {c1, c2}.

For example, a DCI format (denotes as DCI #8) may schedule at least one PDSCH on at least one serving cell in a set of serving cells for multi-cell scheduling and indicate SCell dormancy for a certain serving cell (e.g., cell #G). DCI #8 can be regarded as scheduling the at least one serving cell and cell #G. That is, DCI #8 can be regarded as scheduling the at least one PDSCH on the at least one serving cell and a virtual PDSCH on cell #G. In some examples, the virtual PDSCH is assumed to provide one TB which has been correctly decoded by the UE, and an “ACK” bit can be generated for the virtual PDSCH. HARQ-ACK information bit(s) for an actually scheduled PDSCH may depend on the decoding result of the PDSCH at a UE. HARQ-ACK information bits corresponding to DCI #8 may include HARQ-ACK information for the virtual PDSCH and the actually scheduled PDSCH(s), and can be ordered based on (e.g., in an ascending or descending order of) associated serving cell indexes among the at least one (actually scheduled) serving cell and (virtually scheduled) cell #G.

As described above, SCell dormancy indication in a DCI format may be achieved by reinterpreting a predefined set of DCI fields. For example, in the case that the value of one FDRA field in DCI #8 corresponding to a certain cell is set to be invalid, this cell is cell #G. For example, in the case that the values of a plurality of FDRA fields in DCI #8 corresponding to a plurality of cells are set to be invalid, cell #G may be the cell with a predefined cell index (e.g., smallest cell index) among the plurality of cells.

Referring to FIG. 6, a HARQ-ACK codebook may include sub-codebook 611 and sub-codebook 612 and may be transmitted at PUCCH 631. Sub-codebook 611 may be an instance of the aforementioned sub-codebook #1. Sub-codebook 612 may be an instance of the aforementioned sub-codebook #2. For example, sub-codebook 611 may include HARQ-ACK information bits corresponding to DCI formats each having a single HARQ-ACK information bit. For example, sub-codebook 612 may include HARQ-ACK information bits corresponding to DCI formats 1_3 each having more than one HARQ-ACK information bit. Sub-codebook 612 may be generated by concatenating HARQ-ACK information bits corresponding to all of the DCI formats 1_3 with each scheduling more than one PDSCH (including virtual or actual PDSCH).

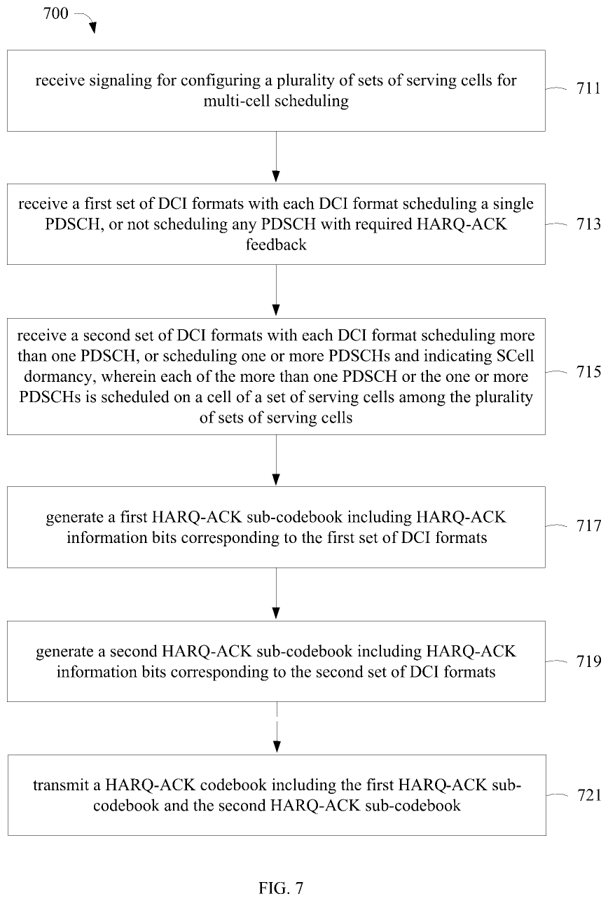

FIG. 7 illustrates a flowchart of method 700 for wireless communication in accordance with some embodiments of the present disclosure. Details described in all of the foregoing embodiments of the present disclosure are applicable for the embodiments shown in FIG. 7. In some examples, method 700 may be performed by a UE, for example, UE 104 as described with reference to FIG. 1. In some embodiments, the UE may execute a set of instructions to control the functional elements of the UE to perform the described functions or operations. In some examples, a processor of a UE may cause the UE to perform method 700.

At 711, a UE may receive signaling for configuring a plurality of sets of serving cells for multi-cell scheduling. At 713, the UE may receive a first set of DCI formats with each DCI format scheduling a single PDSCH, or not scheduling any PDSCH with required HARQ-ACK feedback. At 715, the UE may receive a second set of DCI formats with each DCI format scheduling more than one PDSCH, or scheduling one or more PDSCHs and indicating SCell dormancy, wherein each of the more than one PDSCH or the one or more PDSCHs is scheduled on a cell of a set of serving cells among the plurality of sets of serving cells.

At 717, the UE may generate a first HARQ-ACK sub-codebook including HARQ-ACK information bits corresponding to the first set of DCI formats. At 719, the UE may generate a second HARQ-ACK sub-codebook including HARQ-ACK information bits corresponding to the second set of DCI formats. At 721, the UE may transmit a HARQ-ACK codebook including the first HARQ-ACK sub-codebook and the second HARQ-ACK sub-codebook.

In some embodiments, each DCI format of the first set of DCI formats includes a counter DAI indicating an accumulative number of pairs of a serving cell and a PDCCH monitoring occasion in which a PDSCH reception with HARQ-ACK feedback enabled or a DCI format with HARQ-ACK feedback required is present, up to a current serving cell and a current PDCCH monitoring occasion.

In some embodiments, counter DAIs of the first set of DCI formats are updated first according to a predefined order of serving cell indexes and then according to a predefined order of PDCCH monitoring occasion indexes.

In some embodiments, in the case that the first set of DCI formats includes at least two DCI formats in a same PDCCH monitoring occasion scheduling respective PDSCHs on a same serving cell, counter DAIs of the at least two DCI formats are updated according to a predefined order of start times for receiving the respective PDSCHs.

In some embodiments, the HARQ-ACK information bits in the first HARQ-ACK sub-codebook are ordered based on counter DAIs of the first set of DCI formats.

In some embodiments, the second HARQ-ACK sub-codebook includes one or more parts, each of which corresponds to a set of serving cells scheduled by the second set of DCI formats among the plurality of sets of serving cells. The one or more parts are ordered based on set indexes of sets of serving cells scheduled by the second set of DCI formats.

In some embodiments, a first DCI format of the second set of DCI formats schedules a serving cell in a first set of serving cells among the plurality of sets of serving cells and a number of HARQ-ACK information bits corresponding to the first DCI format depends on a maximum number of HARQ-ACK information bits per DCI format among DCI formats scheduling the first set of serving cells.

In some embodiments, a first DCI format of the second set of DCI formats schedules a serving cell in a first set of serving cells among the plurality of sets of serving cells, and wherein the first DCI format includes a counter DAI indicating an accumulative number of pairs of a serving cell with a smallest serving cell index among more than one scheduled serving cells and a PDCCH monitoring occasion in which PDSCH receptions are present, up to current more than one scheduled serving cells in the first set of serving cells and a current PDCCH monitoring occasion.

In some embodiments, each DCI format of the second set of DCI formats includes a counter DAI and wherein counter DAIs of DCI formats scheduling different sets of serving cells in the second set of DCI formats are counted separately. In some embodiments, wherein HARQ-ACK information bits in each part of the one or more parts are ordered based on counter DAI(s) of DCI format(s) scheduling a corresponding set of serving cells in the second set of DCI formats.

In some embodiments, each DCI format of the second set of DCI formats includes a counter DAI which is counted among all DCI formats of the second set of DCI formats. In some embodiments, wherein the HARQ-ACK information bits corresponding to the second set of DCI formats in the second HARQ-ACK sub-codebook are ordered based on counter DAI(s) of the second set of DCI formats.

In some embodiments, a first DCI format of the second set of DCI formats schedules a serving cell in a first set of serving cells among the plurality of sets of serving cells and a number of HARQ-ACK information bits corresponding to the first DCI format depends on that of a DCI format having a maximum number of HARQ-ACK information bits among the second set of DCI formats.

In some embodiments, the first DCI format includes a counter DAI indicating an accumulative number of pairs of a serving cell with a smallest serving cell index among more than one scheduled serving cells and a PDCCH monitoring occasion in which PDSCH receptions are present, up to current more than one scheduled serving cells and a current PDCCH monitoring occasion.

In some embodiments, the counter DAI is updated first according to a predefined order of the smallest serving cell index among the more than one scheduled serving cells and then according to a predefined order of PDCCH monitoring occasion index.

In some embodiments, in the case that the second set of DCI formats includes at least two DCI formats in a same PDCCH monitoring occasion and the at least two DCI formats schedule respective PDSCHs on a same serving cell having the smallest serving cell index among respective serving cells scheduled by the at least two DCI formats, counter DAIs of the at least two DCI formats are updated according to a predefined order of start times for receiving the respective PDSCHs.

In some embodiments, the first DCI format schedules a plurality of serving cells in the first set of serving cells, and wherein the current more than one scheduled serving cells include the plurality of serving cells and the PDSCH receptions include PDSCH receptions on the plurality of serving cells.

In some embodiments, the first DCI format schedules at least one serving cell in the first set of serving cells and indicates SCell dormancy by reinterpreting a predefined set of fields associated with a first serving cell in the first set of serving cells, and wherein the current more than one scheduled serving cells include the at least one serving cell and the first serving cell and the PDSCH receptions include PDSCH reception(s) on the at least one serving cell and a virtual PDSCH reception on the first serving cell.

In some embodiments, a first DCI format of the second set of DCI formats schedules a plurality of serving cells in a first set of serving cells, and HARQ-ACK information bits corresponding to the first DCI format are ordered based on serving cell indexes of the plurality of serving cells.

In some embodiments, a first DCI format schedules at least one serving cell in a first set of serving cells and indicates SCell dormancy by reinterpreting a predefined set of fields associated with a first serving cell in the first set of serving cells, and HARQ-ACK information bits corresponding to the first DCI format are ordered based on serving cell indexes of the at least one serving cell and the first serving cell.

In some embodiments, the first serving cell is a serving cell with a predefined cell index among cell(s) having invalid FDRA value(s) in the first DCI format among the first set of serving cells.

In some embodiments, each of the second set of DCI formats is received at a different serving cell, or the second set of DCI formats is received at the same serving cell, or one or more DCI formats of the second set of DCI formats are received at the same serving cell and each of the remaining DCI formats of the second set of DCI formats is received at a different serving cell.

It should be appreciated by persons skilled in the art that the sequence of the operations in exemplary method 700 may be changed and some of the operations in exemplary method 700 may be eliminated or modified, without departing from the spirit and scope of the disclosure.

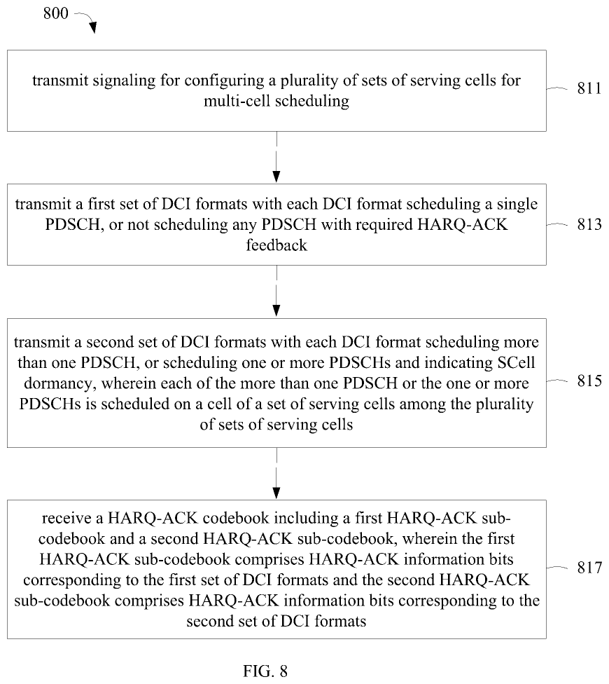

FIG. 8 illustrates a flowchart of method 800 for wireless communication in accordance with some embodiments of the present disclosure. Details described in all of the foregoing embodiments of the present disclosure are applicable for the embodiments shown in FIG. 8. In some examples, method 800 may be performed by a BS or an NE (for example, NE 102 as described with reference to FIG. 1). In some embodiments, the BS or the NE may execute a set of instructions to control the functional elements of the BS or the NE to perform the described functions or operations. In some examples, a processor of an NE may cause the NE to perform method 800.

At 811, a BS may transmit signaling for configuring a plurality of sets of serving cells for multi-cell scheduling. At 813, the BS may transmit a first set of DCI formats with each DCI format scheduling a single PDSCH, or not scheduling any PDSCH with required HARQ-ACK feedback. At 815, the BS may transmit a second set of DCI formats with each DCI format scheduling more than one PDSCH, or scheduling one or more PDSCHs and indicating SCell dormancy, wherein each of the more than one PDSCH or the one or more PDSCHs is scheduled on a cell of a set of serving cells among the plurality of sets of serving cells. At 817, the BS may receive a HARQ-ACK codebook including a first HARQ-ACK sub-codebook and a second HARQ-ACK sub-codebook, wherein the first HARQ-ACK sub-codebook includes HARQ-ACK information bits corresponding to the first set of DCI formats and the second HARQ-ACK sub-codebook includes HARQ-ACK information bits corresponding to the second set of DCI formats.

In some embodiments, each DCI format of the first set of DCI formats includes a counter DAI indicating an accumulative number of pairs of a serving cell and a PDCCH monitoring occasion in which a PDSCH transmission with HARQ-ACK feedback enabled or a DCI format with HARQ-ACK feedback required is present, up to a current serving cell and a current PDCCH monitoring occasion.

In some embodiments, counter DAIs of the first set of DCI formats are updated first according to a predefined order of serving cell indexes and then according to a predefined order of PDCCH monitoring occasion indexes.

In some embodiments, in the case that the first set of DCI formats includes at least two DCI formats in a same PDCCH monitoring occasion scheduling respective PDSCHs on a same serving cell, counter DAIs of the at least two DCI formats are updated according to a predefined order of start times for transmitting the respective PDSCHs.

In some embodiments, the HARQ-ACK information bits in the first HARQ-ACK sub-codebook are ordered based on counter DAIs of the first set of DCI formats.

In some embodiments, the second HARQ-ACK sub-codebook includes one or more parts, each of which corresponds to a set of serving cells scheduled by the second set of DCI formats among the plurality of sets of serving cells. The one or more parts are ordered based on set indexes of sets of serving cells scheduled by the second set of DCI formats.

In some embodiments, a first DCI format of the second set of DCI formats schedules a serving cell in a first set of serving cells among the plurality of sets of serving cells and a number of HARQ-ACK information bits corresponding to the first DCI format depends on a maximum number of HARQ-ACK information bits per DCI format among DCI formats scheduling the first set of serving cells.

In some embodiments, a first DCI format of the second set of DCI formats schedules a serving cell in a first set of serving cells among the plurality of sets of serving cells, and wherein the first DCI format includes a counter DAI indicating an accumulative number of pairs of a serving cell with a smallest serving cell index among more than one scheduled serving cells and PDCCH monitoring occasion in which PDSCH transmissions are present, up to current more than one scheduled serving cells in the first set of serving cells and a current PDCCH monitoring occasion.

In some embodiments, each DCI format of the second set of DCI formats includes a counter DAI and wherein counter DAIs of DCI formats scheduling different sets of serving cells in the second set of DCI formats are counted separately. In some embodiments, HARQ-ACK information bits in each part of the one or more parts are ordered based on counter DAI(s) of DCI format(s) scheduling a corresponding set of serving cells in the second set of DCI formats.

In some embodiments, each DCI format of the second set of DCI formats includes a counter DAI which is counted among all DCI formats of the second set of DCI formats. In some embodiments, the HARQ-ACK information bits corresponding to the second set of DCI formats in the second HARQ-ACK sub-codebook are ordered based on counter DAI(s) of the second set of DCI formats.

In some embodiments, a first DCI format of the second set of DCI formats schedules a serving cell in a first set of serving cells among the plurality of sets of serving cells and a number of HARQ-ACK information bits corresponding to the first DCI format depends on that of a DCI format having a maximum number of HARQ-ACK information bits among the second set of DCI formats.

In some embodiments, the first DCI format includes a counter DAI indicating an accumulative number of pairs of a serving cell with a smallest serving cell index among more than one scheduled serving cells and PDCCH monitoring occasion in which PDSCH transmissions are present, up to current more than one scheduled serving cells and a current PDCCH monitoring occasion.

In some embodiments, the counter DAI is updated first according to a predefined order of the smallest serving cell index among the more than one scheduled serving cells and then according to a predefined order of PDCCH monitoring occasion index.

In some embodiments, in the case that the second set of DCI formats includes at least two DCI formats in a same PDCCH monitoring occasion and the at least two DCI formats schedule respective PDSCHs on a same serving cell having the smallest serving cell index among respective serving cells scheduled by the at least two DCI formats, counter DAIs of the at least two DCI formats are updated according to a predefined order of start times for transmitting the respective PDSCHs.

In some embodiments, the first DCI format schedules a plurality of serving cells in the first set of serving cells, and wherein the current more than one scheduled serving cells include the plurality of serving cells and the PDSCH transmissions include PDSCH transmissions on the plurality of serving cells.

In some embodiments, the first DCI format schedules at least one serving cell in the first set of serving cells and indicates SCell dormancy by reinterpreting a predefined set of fields associated with a first serving cell in the first set of serving cells, and wherein the current more than one scheduled serving cells include the at least one serving cell and the first serving cell and the PDSCH transmissions include PDSCH transmission(s) on the at least one serving cell and a virtual PDSCH transmission on the first serving cell.

In some embodiments, a first DCI format of the second set of DCI formats schedules a plurality of serving cells in a first set of serving cells, and HARQ-ACK information bits corresponding to the first DCI format are ordered based on serving cell indexes of the plurality of serving cells.

In some embodiments, a first DCI format schedules at least one serving cell in a first set of serving cells and indicates SCell dormancy by reinterpreting a predefined set of fields associated with a first serving cell in the first set of serving cells, and HARQ-ACK information bits corresponding to the first DCI format are ordered based on serving cell indexes of the at least one serving cell and the first serving cell.

In some embodiments, the first serving cell is a serving cell with a predefined cell index among cell(s) having invalid FDRA value(s) in the first DCI format among the first set of serving cells.

In some embodiments, each of the second set of DCI formats is transmitted at a different serving cell, or the second set of DCI formats is transmitted at the same serving cell, or one or more DCI formats of the second set of DCI formats are transmitted at the same serving cell and each of the remaining DCI formats of the second set of DCI formats is transmitted at a different serving cell.

It should be appreciated by persons skilled in the art that the sequence of the operations in exemplary method 800 may be changed and some of the operations in exemplary method 800 may be eliminated or modified, without departing from the spirit and scope of the disclosure.

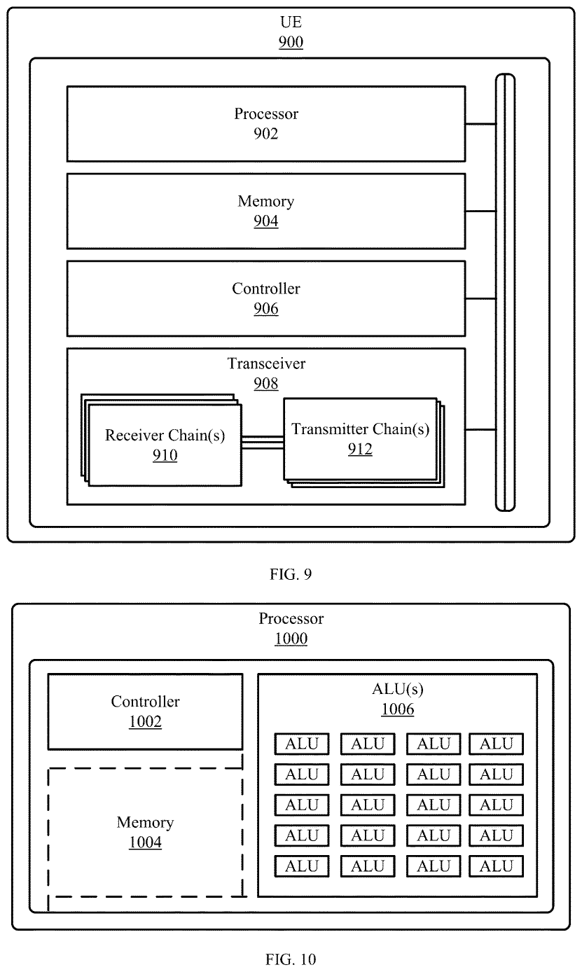

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904). For example, the processor 902 may support wireless communication at the UE 900 in accordance with examples as disclosed herein. For example, the UE 900 may be configured to support means for performing the operations as described with respect to FIG. 7.

For example, the UE 900 may be configured to support: a means for receiving signaling for configuring a plurality of sets of serving cells for multi-cell scheduling; a means for receiving a first set of DCI formats with each DCI format scheduling a single PDSCH, or not scheduling any PDSCH with required HARQ-ACK feedback; a means for receiving a second set of DCI formats with each DCI format scheduling more than one PDSCH, or scheduling one or more PDSCHs and indicating SCell dormancy, wherein each of the more than one PDSCH or the one or more PDSCHs is scheduled on a cell of a set of serving cells among the plurality of sets of serving cells; a means for generating a first HARQ-ACK sub-codebook including HARQ-ACK information bits corresponding to the first set of DCI formats; a means for generating a second HARQ-ACK sub-codebook including HARQ-ACK information bits corresponding to the second set of DCI formats; and a means for transmitting a HARQ-ACK codebook including the first HARQ-ACK sub-codebook and the second HARQ-ACK sub-codebook.

The controller 906 may manage input and output signals for the UE 900. The controller 906 may also manage peripherals not integrated into the UE 900. In some implementations, the controller 906 may utilize an operating system such as iOS®, ANDROID®, WINDOWS®), or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, or packets) over a wireless medium. For example, the receiver chain 910 may include one or more antennas for receive the signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the processing the demodulated signal to receive the transmitted data.

A transmitter chain 912 may be configured to generate and transmit signals (e.g., control information, data, or packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

It should be appreciated by persons skilled in the art that the components in exemplary UE 900 may be changed, for example, some of the components in exemplary UE 900 may be omitted or modified or a new component(s) may be added to exemplary UE 900, without departing from the spirit and scope of the disclosure. For example, in some embodiments, the UE 900 may not include the controller 906.

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine a subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs, and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein.

For example, the processor 1000 may be configured to support means for performing the operations as described with respect to FIG. 7. For example, the processor 1000 may be configured to or operable to support: a means for receiving signaling for configuring a plurality of sets of serving cells for multi-cell scheduling; a means for receiving a first set of DCI formats with each DCI format scheduling a single PDSCH, or not scheduling any PDSCH with required HARQ-ACK feedback; a means for receiving a second set of DCI formats with each DCI format scheduling more than one PDSCH, or scheduling one or more PDSCHs and indicating SCell dormancy, wherein each of the more than one PDSCH or the one or more PDSCHs is scheduled on a cell of a set of serving cells among the plurality of sets of serving cells; a means for generating a first HARQ-ACK sub-codebook including HARQ-ACK information bits corresponding to the first set of DCI formats; a means for generating a second HARQ-ACK sub-codebook including HARQ-ACK information bits corresponding to the second set of DCI formats; and a means for transmitting a HARQ-ACK codebook including the first HARQ-ACK sub-codebook and the second HARQ-ACK sub-codebook.

For example, the processor 1000 may be configured to support means for performing the operations as described with respect to FIG. 8. For example, the processor 1000 may be configured to or operable to support: a means for transmitting signaling for configuring a plurality of sets of serving cells for multi-cell scheduling; a means for transmitting a first set of DCI formats with each DCI format scheduling a single PDSCH, or not scheduling any PDSCH with required HARQ-ACK feedback; a means for transmitting a second set of DCI formats with each DCI format scheduling more than one PDSCH, or scheduling one or more PDSCHs and indicating SCell dormancy, wherein each of the more than one PDSCH or the one or more PDSCHs is scheduled on a cell of a set of serving cells among the plurality of sets of serving cells; and a means for receiving a HARQ-ACK codebook including a first HARQ-ACK sub-codebook and a second HARQ-ACK sub-codebook, wherein the first HARQ-ACK sub-codebook includes HARQ-ACK information bits corresponding to the first set of DCI formats and the second HARQ-ACK sub-codebook includes HARQ-ACK information bits corresponding to the second set of DCI formats.

It should be appreciated by persons skilled in the art that the components in exemplary processor 1000 may be changed, for example, some of the components in exemplary processor 1000 may be omitted or modified or a new component(s) may be added to exemplary processor 1000, without departing from the spirit and scope of the disclosure. For example, in some embodiments, the processor 1000 may not include the ALUs 1006.

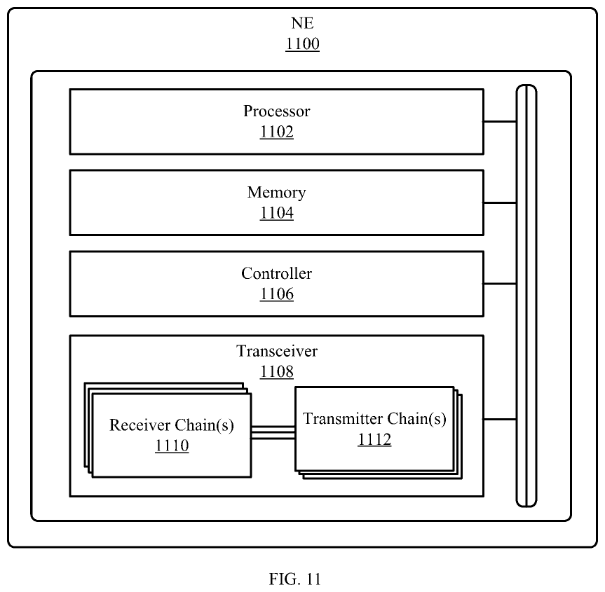

FIG. 11 illustrates an example of an NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. For example, the NE 1100 may be configured to support means for performing the operations as described with respect to FIG. 8.

For example, the NE 1100 may be configured to support: a means for transmitting signaling for configuring a plurality of sets of serving cells for multi-cell scheduling; a means for transmitting a first set of DCI formats with each DCI format scheduling a single PDSCH, or not scheduling any PDSCH with required HARQ-ACK feedback; a means for transmitting a second set of DCI formats with each DCI format scheduling more than one PDSCH, or scheduling one or more PDSCHs and indicating SCell dormancy, wherein each of the more than one PDSCH or the one or more PDSCHs is scheduled on a cell of a set of serving cells among the plurality of sets of serving cells; and a means for receiving a HARQ-ACK codebook including a first HARQ-ACK sub-codebook and a second HARQ-ACK sub-codebook, wherein the first HARQ-ACK sub-codebook includes HARQ-ACK information bits corresponding to the first set of DCI formats and the second HARQ-ACK sub-codebook includes HARQ-ACK information bits corresponding to the second set of DCI formats.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, or packets) over a wireless medium. For example, the receiver chain 1110 may include one or more antennas for receive the signal over the air or wireless medium. The receiver chain 1110 may include at least one amplifier (e.g., an LNA) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the processing the demodulated signal to receive the transmitted data.

A transmitter chain 1112 may be configured to generate and transmit signals (e.g., control information, data, or packets). The transmitter chain 1112may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

It should be appreciated by persons skilled in the art that the components in exemplary NE 1100 may be changed, for example, some of the components in exemplary NE 1100 may be omitted or modified or a new component(s) may be added to exemplary NE 1100, without departing from the spirit and scope of the disclosure. For example, in some embodiments, the NE 1100 may not include the controller 1106.

Those having ordinary skill in the art would understand that the operations or steps of the methods described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of the methods may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. The disclosure is not limited to the examples and designs described herein but is to be accorded with the broadest scope consistent with the principles and novel features disclosed herein. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” or the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE), comprising:
at least one memory; and
at least one processor coupled with the at least one memory and configured to cause the UE to:
receive signaling for configuring a plurality of sets of serving cells for multi-cell scheduling;
receive a first set of downlink control information (DCI) formats with each DCI format scheduling a single physical downlink shared channel (PDSCH), or not scheduling any PDSCH and requiring hybrid automatic repeat request acknowledgement (HARQ-ACK) feedback;
receive a second set of DCI formats with each DCI format scheduling more than one PDSCH, or scheduling one or more PDSCHs and indicating secondary cell (SCell) dormancy, wherein each of the more than one PDSCH or the one or more PDSCHs is scheduled on a cell of a set of serving cells among the plurality of sets of serving cells;
generate a first HARQ-ACK sub-codebook comprising HARQ-ACK information bits corresponding to the first set of DCI formats;
generate a second HARQ-ACK sub-codebook comprising HARQ-ACK information bits corresponding to the second set of DCI formats; and
transmit a HARQ-ACK codebook comprising the first HARQ-ACK sub-codebook and the second HARQ-ACK sub-codebook.

2. The UE of claim 1, wherein the second HARQ-ACK sub-codebook comprises one or more parts, each of which corresponds to a set of serving cells scheduled by the second set of DCI formats among the plurality of sets of serving cells; and
wherein the one or more parts are ordered based on set indexes of sets of serving cells scheduled by the second set of DCI formats.

3. The UE of claim 2, wherein a first DCI format of the second set of DCI formats schedules a serving cell in a first set of serving cells among the plurality of sets of serving cells and a number of HARQ-ACK information bits corresponding to the first DCI format depends on a maximum number of HARQ-ACK information bits per DCI format among DCI formats scheduling the first set of serving cells.

4. The UE of claim 2, wherein a first DCI format of the second set of DCI formats schedules a serving cell in a first set of serving cells among the plurality of sets of serving cells, and wherein the first DCI format comprises a counter downlink assignment indicator (DAI) indicating an accumulative number of pairs of a serving cell with a smallest serving cell index among more than one scheduled serving cells and a physical downlink control channel (PDCCH) monitoring occasion in which PDSCH receptions are present, up to current more than one scheduled serving cells in the first set of serving cells and a current PDCCH monitoring occasion.

5. The UE of claim 2, wherein each DCI format of the second set of DCI formats comprises a counter downlink assignment indicator (DAI) and wherein counter DAIs of DCI formats scheduling different sets of serving cells in the second set of DCI formats are counted separately; and
wherein HARQ-ACK information bits in each part of the one or more parts are ordered based on counter DAI(s) of DCI format(s) scheduling a corresponding set of serving cells in the second set of DCI formats.

6. The UE of claim 1, wherein each DCI format of the second set of DCI formats comprises a counter downlink assignment indicator (DAI) which is counted among all DCI formats of the second set of DCI formats; and
wherein the HARQ-ACK information bits corresponding to the second set of DCI formats in the second HARQ-ACK sub-codebook are ordered based on counter DAI(s) of the second set of DCI formats.

7. The UE of claim 1, wherein a first DCI format of the second set of DCI formats schedules a serving cell in a first set of serving cells among the plurality of sets of serving cells and a number of HARQ-ACK information bits corresponding to the first DCI format depends on that of a DCI format having a maximum number of HARQ-ACK information bits among the second set of DCI formats.

8. The UE of claim 7, wherein the first DCI format comprises a counter downlink assignment indicator (DAI) indicating an accumulative number of pairs of a serving cell with a smallest serving cell index among more than one scheduled serving cells and a physical downlink control channel (PDCCH) monitoring occasion in which PDSCH receptions are present, up to current more than one scheduled serving cells and a current PDCCH monitoring occasion.

9. The UE of claim 4 or 8, wherein the counter DAI is updated first according to a predefined order of the smallest serving cell index among the more than one scheduled serving cells and then according to a predefined order of PDCCH monitoring occasion index.

10. The UE of claim 4 or 8, wherein the first DCI format schedules a plurality of serving cells in the first set of serving cells, and wherein the current more than one scheduled serving cells comprise the plurality of serving cells and the PDSCH receptions comprise PDSCH receptions on the plurality of serving cells; or
wherein the first DCI format schedules at least one serving cell in the first set of serving cells and indicates SCell dormancy by reinterpreting a predefined set of fields associated with a first serving cell in the first set of serving cells, and wherein the current more than one scheduled serving cells comprise the at least one serving cell and the first serving cell and the PDSCH receptions comprise PDSCH reception(s) on the at least one serving cell and a virtual PDSCH reception on the first serving cell.

11. The UE of claim 1, wherein a first DCI format of the second set of DCI formats schedules a plurality of serving cells in a first set of serving cells, and HARQ-ACK information bits corresponding to the first DCI format are ordered based on serving cell indexes of the plurality of serving cells; or
wherein a first DCI format schedules at least one serving cell in a first set of serving cells and indicates SCell dormancy by reinterpreting a predefined set of fields associated with a first serving cell in the first set of serving cells, and HARQ-ACK information bits corresponding to the first DCI format are ordered based on serving cell indexes of the at least one serving cell and the first serving cell.

12. The UE of claim 11, wherein the first serving cell is a serving cell with a predefined cell index among cell(s) having invalid frequency domain resource assignment (FDRA) value(s) in the first DCI format among the first set of serving cells.

13. A base station (BS), comprising:
at least one memory; and
at least one processor coupled with the at least one memory and configured to cause the BS to:
transmit signaling for configuring a plurality of sets of serving cells for multi-cell scheduling;
transmit a first set of downlink control information (DCI) formats with each DCI format scheduling a single physical downlink shared channel (PDSCH), or not scheduling any PDSCH and requiring hybrid automatic repeat request acknowledgement (HARQ-ACK) feedback;
transmit a second set of DCI formats with each DCI format scheduling more than one PDSCH, or scheduling one or more PDSCHs and indicating secondary cell (SCell) dormancy, wherein each of the more than one PDSCH or the one or more PDSCHs is scheduled on a cell of a set of serving cells among the plurality of sets of serving cells; and
receive a HARQ-ACK codebook comprising a first HARQ-ACK sub-codebook and a second HARQ-ACK sub-codebook, wherein the first HARQ-ACK sub-codebook comprises HARQ-ACK information bits corresponding to the first set of DCI formats and the second HARQ-ACK sub-codebook comprises HARQ-ACK information bits corresponding to the second set of DCI formats.

14. The BS of claim 13, wherein the second HARQ-ACK sub-codebook comprises one or more parts, each of which corresponds to a set of serving cells scheduled by the second set of DCI formats among the plurality of sets of serving cells; and
wherein the one or more parts are ordered based on set indexes of sets of serving cells scheduled by the second set of DCI formats.

15. The BS of claim 14, wherein a first DCI format of the second set of DCI formats schedules a serving cell in a first set of serving cells among the plurality of sets of serving cells, and wherein the first DCI format comprises a counter downlink assignment indicator (DAI) indicating an accumulative number of pairs of a serving cell with a smallest serving cell index among more than one scheduled serving cells and physical downlink control channel (PDCCH) monitoring occasion in which PDSCH transmissions are present, up to current more than one scheduled serving cells in the first set of serving cells and a current PDCCH monitoring occasion.

16. The BS of claim 14, wherein each DCI format of the second set of DCI formats comprises a counter downlink assignment indicator (DAI) and wherein counter DAIs of DCI formats scheduling different sets of serving cells in the second set of DCI formats are counted separately; and
wherein HARQ-ACK information bits in each part of the one or more parts are ordered based on counter DAI(s) of DCI format(s) scheduling a corresponding set of serving cells in the second set of DCI formats.

17. The BS of claim 13, wherein each DCI format of the second set of DCI formats comprises a counter downlink assignment indicator (DAI) which is counted among all DCI formats of the second set of DCI formats; and
wherein the HARQ-ACK information bits corresponding to the second set of DCI formats in the second HARQ-ACK sub-codebook are ordered based on counter DAI(s) of the second set of DCI formats.

18. The BS of claim 13, wherein a first DCI format of the second set of DCI formats schedules a plurality of serving cells in a first set of serving cells, and HARQ-ACK information bits corresponding to the first DCI format are ordered based on serving cell indexes of the plurality of serving cells; or
wherein a first DCI format schedules at least one serving cell in a first set of serving cells and indicates SCell dormancy by reinterpreting a predefined set of fields associated with a first serving cell in the first set of serving cells, and HARQ-ACK information bits corresponding to the first DCI format are ordered based on serving cell indexes of the at least one serving cell and the first serving cell.

19. A processor, comprising:
at least one controller coupled with at least one memory and configured to cause the processor to:
receive signaling for configuring a plurality of sets of serving cells for multi-cell scheduling;
receive a first set of downlink control information (DCI) formats with each DCI format scheduling a single physical downlink shared channel (PDSCH), or not scheduling any PDSCH and requiring hybrid automatic repeat request acknowledgement (HARQ-ACK) feedback;
receive a second set of DCI formats with each DCI format scheduling more than one PDSCH, or scheduling one or more PDSCHs and indicating secondary cell (SCell) dormancy, wherein each of the more than one PDSCH or the one or more PDSCHs is scheduled on a cell of a set of serving cells among the plurality of sets of serving cells;
generate a first HARQ-ACK sub-codebook comprising HARQ-ACK information bits corresponding to the first set of DCI formats;
generate a second HARQ-ACK sub-codebook comprising HARQ-ACK information bits corresponding to the second set of DCI formats; and
transmit a HARQ-ACK codebook comprising the first HARQ-ACK sub-codebook and the second HARQ-ACK sub-codebook.

20. A method for wireless communication, comprising:
receiving signaling for configuring a plurality of sets of serving cells for multi-cell scheduling;
receiving a first set of downlink control information (DCI) formats with each DCI format scheduling a single physical downlink shared channel (PDSCH), or not scheduling any PDSCH and requiring hybrid automatic repeat request acknowledgement (HARQ-ACK) feedback;
receiving a second set of DCI formats with each DCI format scheduling more than one PDSCH, or scheduling one or more PDSCHs and indicating secondary cell (SCell) dormancy, wherein each of the more than one PDSCH or the one or more PDSCHs is scheduled on a cell of a set of serving cells among the plurality of sets of serving cells;
generating a first HARQ-ACK sub-codebook comprising HARQ-ACK information bits corresponding to the first set of DCI formats;
generating a second HARQ-ACK sub-codebook comprising HARQ-ACK information bits corresponding to the second set of DCI formats; and
transmitting a HARQ-ACK codebook comprising the first HARQ-ACK sub-codebook and the second HARQ-ACK sub-codebook.
